(19) United States
(12) Patent Application Publication
(10) Pub. No.: US 2008/0212789 A1
(43) Pub. Date: Sep. 4, 2008

(54) At-Home Hearing Aid Training System and Method

(75) Inventors: John Cronin, Jericho, VT (US); Tushar Narsana, Naperville, IL (US); Steven A. Shaya, Highlands, NJ (US)

Correspondence Address: MCCARTER & ENGLISH, LLP, FOUR GATEWAY CENTER, 100 MULBERRY STREET, NEWARK, NJ, 07102, US

(73) Assignee: JOHNSON & JOHNSON CONSUMER COMPANIES, INC., Skillman, NJ (US)

(21) Appl. No.: 11/570,467

(22) PCT Filed: Jun. 13, 2005
(86) PCT No.: PCT/US2005/020823

§ 371 Date: Oct. 2, 2007

Related U.S. Application Data
(60) Provisional application No. 60/579,366, filed on Jun. 14, 2004.

(51) Int. Cl. H04R 29/00

(52) U.S. Cl. 381/60

(57) ABSTRACT

The present invention is a system for and method of training an individual on the use of a hearing aid. The training is conducted based on the individuals hearing profile such that specific words that are troublesome to the user are played to the user after changing the frequency and amplitude of the words, i.e. the user is trained on how the words will sound after wearing a hearing aid. The user can further fine-tune the frequency and amplitude of the words, and the modifications can be saved and used while ordering and fitting a hearing aid.

### CROSS REFERENCE TO RELATED APPLICATION

This application claims the benefit of U.S. Provisional Application No. 60/579,366 filed Jun. 14, 2004, assigned to the assignee of this application and incorporated by reference herein.

### FIELD OF THE INVENTION

The present invention relates to hearing aid training systems. More particularly, the present invention relates to administering hearing aid training on a compact disc (CD) that is playable on a standard CD player. The CD is pre-programmed and customized for a particular user based on the user's hearing loss characteristics, which have been determined in prior hearing tests, and on the knowledge of how the correction factors programmed into the hearing aid affect the user's hearing. The user wears his or her hearing aid and listens to the CD to be trained on words and sentences that were difficult for the user to hear previously without assistance. Using codes, the CD is capable of turning the hearing aid on and off.

### BACKGROUND OF THE INVENTION

According to the National Institute on Deafness and Other Communication Disorders (NIDCD), approximately 28 million Americans have hearing loss and approximately 1.4 million individuals over the age of three are deaf in both ears. The International Journal of Technology Assessment in Health Care estimates that hearing loss could cost society as much as $297,000 over the lifetime of an affected individual. As the baby boomer population ages, the impact of hearing loss becomes even more serious and widespread. There is a natural onset of hearing loss after the age of 35.

Unfortunately, the majority of the population is either unaware of or does not seek assistance for their hearing difficulties. The Hearing Review reports that three out of five older Americans and six out of seven middle-aged Americans do not use a hearing-aid device. There are several reasons for this. First, the individual may not understand the severity of his or her hearing loss. As the brain continuously adjusts over time to compensate for hearing loss, it trains itself to believe it hears everything correctly. Price is also a concern. According to the Better Hearing Institute, 7 million individuals who would benefit from a hearing aid cannot afford one. Finally, many are concerned with the negative images associated with wearing such a device.

Until the mid-1980s, traditional hearing aids were based on analog technology and merely acted as amplifiers. In the mid-1990s, ten years after their initial introduction, digital-based aids became the accepted standard. A digital signal processor (DSP) was added directly to the hearing aid device, which could be placed either inside or behind the ear. The change in technology allowed an audiologist to perform a hearing test on an individual and customize the hearing aid by programming the DSP. This improved the user's hearing because the DSP could selectively amplify frequency ranges identified as troublesome.

U.S. Pat. No. 6,289,310, assigned to Scientific Learning Corp. and incorporated by reference herein, describes an apparatus for and method of screening an individual's ability to process acoustic events. The '310 patent provides sequences (or trials) of acoustically processed target and distracter phonemes to a subject for identification. The acoustic processing includes amplitude emphasis of selected frequency envelopes, stretching (in the time domain) of selected portions of phonemes, and phase adjustment of selection portions of phonemes relative to a base frequency. After a number of trials, the method of the '310 patent develops a profile for an individual that indicates whether the individual's ability to process acoustic events is within a normal range, and if not, what processing can provide the individual with optimal hearing. The individual's profile can then be used by a listening or processing device to particularly emphasize, stretch, or otherwise manipulate an audio stream to provide the individual with an optimal chance of distinguishing between similar acoustic events.

One problem with the prior art is the absence of a low-cost system for determining troublesome ranges for an individual based on his or her hearing profile. The hearing test usually conducted upon individuals is based solely on testing frequency versus amplitude. Upon receiving and using his or her hearing aid, an individual may have difficulty with specific words and think that the aid is faulty. This can be frustrating to the point that the individual abandons use of the aid altogether. In reality, there are specific words that are difficult for the user to understand until he or she relearns them while using the hearing aid.

A significant proportion of hearing aids are returned to the audiologist after the user has worn the fitted aid for a while (e.g., a few weeks) because the user decides that the hearing aid performs strangely. Unlike a prescription of glasses, which correct to near-perfect vision, hearing aids do not restore perfect hearing and may require a significant retraining period. This is particularly true regarding the way the user interprets speech. Often times, as a person loses his or her hearing in a certain range, certain words become difficult to hear and the user continually asks a speaker to repeat such a word. In essence, the user is retraining his or her brain to associate a different sound with the meaning of the troublesome word. Often, the word is provided in a sentence that provides more context for the brain to be retrained. When a new hearing aid is worn, the user hears the correct audio signals for those troublesome words; however, the user's brain no longer recognizes the correct audio signals because it has retrained itself to recognize the words based upon incorrect audio signals transmitted by deficient hearing. What is needed is a way to train the user of a newly fitted hearing aid to understand the more correct audio signals.

Yet another problem with the prior art is that there is no low-cost system for quickly and efficiently creating such a customized training method.

It is therefore an object of this invention to identify specific troublesome words and sentences within certain frequency and amplitude ranges based on an individual's hearing profile.

It is another object of this invention to reduce the percentage of cancellations of hearing aids by training the user before they receive it. It is estimated that 20% of orders are cancelled before the individual ever receives their hearing aid and an even larger number of hearing aids go unused because the individual does not give his or her brain time to readjust when using the aid.

It is yet another object of the invention to provide the user with customized training for the experience of hearing and listening when using a hearing aid.

It is yet another object of the invention to provide a low-cost system to quickly create this customized training method. For example, an audiologist could perform a hearing exam and immediately output a training product tailored to the consumer.

### SUMMARY OF THE INVENTION

The present invention is a system for and method of creating a training product customized for an individual based on his or her hearing profile, assuming the individual is wearing a hearing aid. This invention provides a method of collecting user information by conducting a hearing test and storing the results in a database. The information is used to order and fit a hearing aid. This invention also provides a method of determining specific, troublesome words the user may find difficult to understand based on the user's hearing profile and the expected performance of the hearing aid. These words are changed to a frequency and amplitude using the DSP in the hearing aid. The hearing test data, in addition to known DSP changes, allows the creation of a customized CD training system containing words and sentences that can be used to train the individual to use the hearing aid, thus minimizing the likelihood that the user will return the hearing aid. Furthermore, the content can be output to a CD using a low-cost system with minimal waiting by the consumer. Finally, this invention provides a method of easily interacting with the training CD.

Thus, the present invention provides for a method of training an individual to use a hearing aid based on hearing loss characteristics of the individual comprising:
collecting frequency and amplitude hearing loss data for the individual by performing a frequency versus amplitude hearing test on the individual;
generating a hearing loss profile map including frequencies requiring amplification and associated amplification factors and perceived hearing values based on the frequency and amplitude data;

providing a troublesome word database, wherein the database includes a plurality of words, wherein each of the words includes at least one frequency component and is indexed in the database in accordance with the at least one frequency component;

generating training word units, wherein each of the training units includes a troublesome word from the word database having at least one frequency component substantially equal to one (e.g., within the range) of the frequencies requiring amplification in the profile map, and wherein each of the training units further includes the amplification factor for the one (e.g. range) of the frequencies requiring amplification; and

storing the training units on data storage units of at least one of a fixed (e.g., central database remotely accessible over the Internet) and portable (e.g, CD or DVD) data storage media, wherein each of the training units is stored on the media including a hearing aid amplification factor activation sound code and such that a normal version and a modified version of the word included in the training unit can be generated as a sound output, wherein the normal version sound output is without any amplification and the modified version sound output includes selected amplification of the word based on the amplification factor.

In a further preferred embodiment, the method includes storing the training units on the media such that the individual can selectively generate, for each of the training units, sound output of the sound code and the normal and modified version of the word of one of the training units, wherein the normal version sound output of the word is automatically generated following selection of the sound code sound output.

In a further preferred embodiment, the method includes storing the training units on the media such that, when the media is initially accessed by the individual, the training units are made accessible to the individual in an order starting from the training unit including the troublesome word likely to be best perceived and terminating at the training unit including the troublesome word likely to be worst perceived by the individual.

Thus, the present invention further provides for a portable data storage media including the above-described training words stored and arranged on the media for providing the above-described functionalities (e.g., selective, user controllable access to normal or modified versions of the words arranged for access from likely to be best perceived to likely to be worst perceived).

### BRIEF DESCRIPTION OF THE DRAWINGS

FIG. 1 is a high-level system diagram of a low-cost hearing testing system that collects user information.

FIG. 2 is a table showing an individual's hearing profile at specific amplitudes for numerous frequencies and the amplification factor needed for adjusting his or her hearing to a normal level.

FIG. 3 is a table showing words and sentences affected by an individual's hearing profile for specific frequencies at low-pass, band-pass, high-pass, and notch hearing types.

FIG. 4 is a high-level system diagram of a computer system that creates an audio training CD that communicates with and collects information from databases that store user information.

FIG. 5 is a flow chart showing how a user interacts with the audio training CD.

### DESCRIPTION OF THE INVENTION

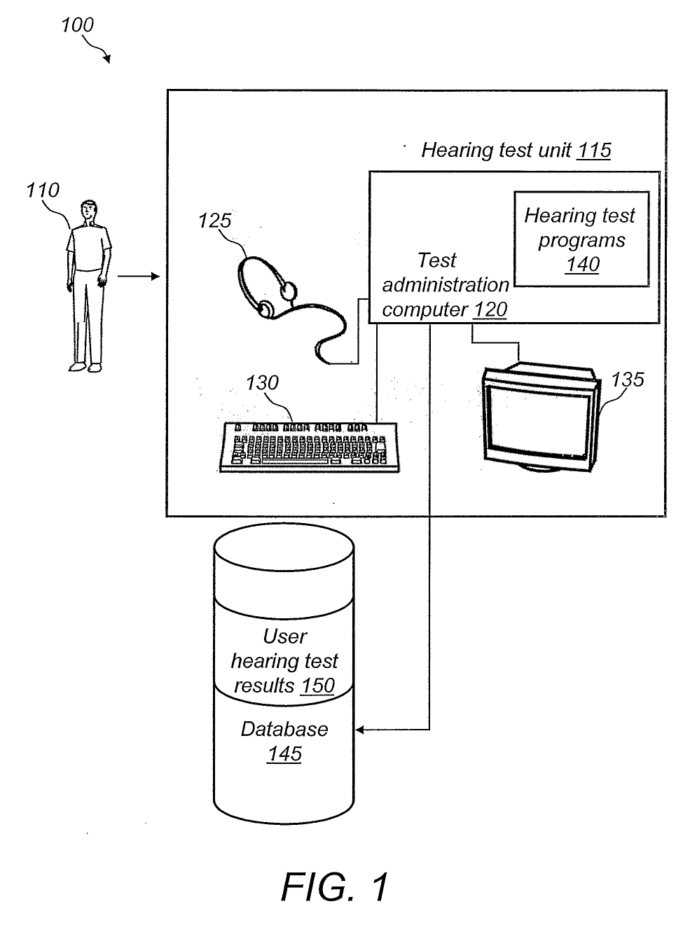

FIG. 1 is a high-level diagram of a system 100, consisting of a user 110, a hearing test unit 115, a test administration computer 120, a pair of headphones 125, a keyboard 130, a monitor 135, a series of hearing test programs 140, a database 145, and a plurality of user hearing test results 150.

User 110 represents an individual on whom a hearing test is to be administered. Hearing test unit 115 includes a test administration computer 120, which includes conventional headphones 125, conventional keyboard 130, and conventional monitor 135, all used for testing. For example, conventional monitor 135 can graphically display test frequencies and amplitudes for user 110, while user 110 is being tested.

Test administration computer 120 runs a series of current hearing test programs 140 and may store the results of the tests. Test administration computer 120 is also responsible for communicating with database 145. Database 145 is a central database repository to store user hearing test results 150 about user 110 or any other test subject, which can later be reused. Database 145 could store an infinite number of individual hearing test results and these results would all be accessible using test administration computer 120 or any other system linked to database 145.

In operation, user 110 wears headphones 125 and uses keyboard 130 and monitor 135 to take hearing test using test administration computer 120 and the series of hearing test programs 140. Individual results 150 of hearing test programs 140 are stored in database 145, which can be either located within test administration computer 120 or centrally located.

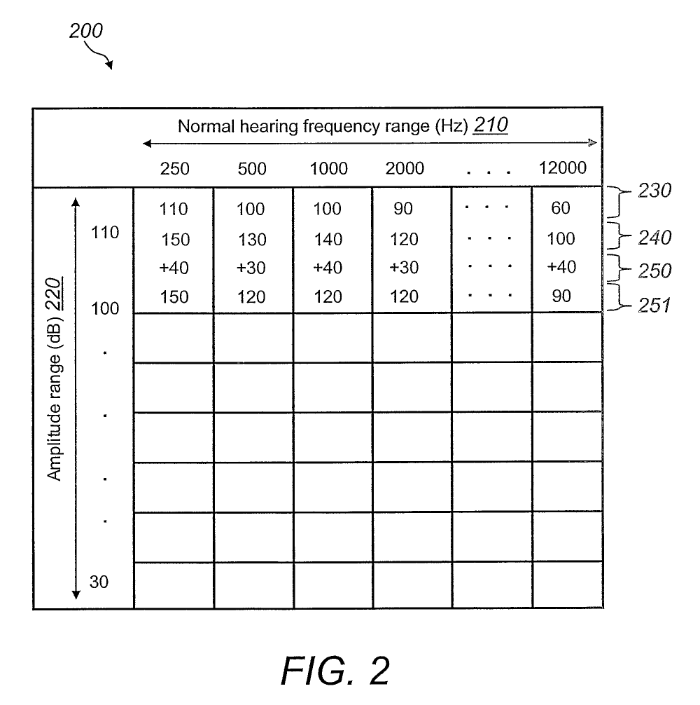

FIG. 2 illustrates a table 200 including a normal hearing frequency range 210, an amplitude range 220, an example of values for individual hearing 230, an example of values for normal hearing 240, an amplification factor 250, and an example of values for perceived hearing 251.

Humans hear at frequencies ranging from 15 to 20,000 hertz (Hz). Normal hearing frequency range 210 shows a smaller range from 250 to 12,000 Hz. During a hearing test as described in FIG. 1, an audiologist may choose to test sounds of different frequency ranges across a series of amplitudes. Amplitude range 220 shows a typical range of 30 to 110 decibels (dB). Individual hearing 230 shows an example of decibel levels by frequency that an individual may hear at 110 dB. Normal hearing 240 shows an example of the decibel levels by frequency that the individual should hear at 110 dB, and amplification factor 250 shows the difference between the values of individual hearing 230 and normal hearing 240 at 110 dB. An audiologist would adjust this individual's hearing aid by programming the DSP using amplification factor 250. The hearing aid would be ordered and amplification factors 250 applied to the DSP of the hearing aid. However, the individual's perceived hearing may still be deficient, as shown by example in FIG. 2 as perceived hearing 251, which is determined by performing a hearing testing on the individual with the hearing aid inserted in an ear and operating as programmed.

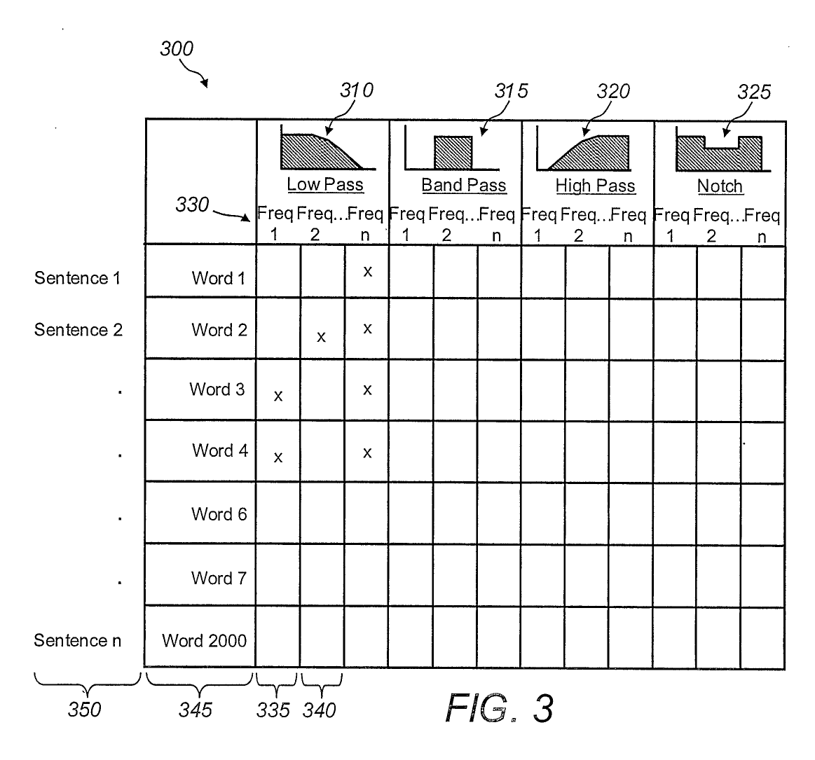

FIG. 3 illustrates a table 300 including a low pass chart 310, a band pass chart 315, a high pass chart 320, a notch chart 325, a range of frequencies 330, a list of words checked for frequency 1 335, a list of words checked for frequency 2 340, a series of words 345, and a series of sentences 350.

For individuals that have a low pass spectrum of hearing, the ear acts as a low pass filter, which means they have fairly good hearing between approximately 250 Hz and approximately 4000 Hz. Frequencies above these are filtered out or minimized. Low pass chart 310 shows an example of this.

For patients that have a band pass spectrum of hearing, the ear acts as a band pass filter, which means they have fairly good hearing between approximately 4000 Hz and approximately 8000 Hz. Outside this range of frequencies, frequencies are filtered out or minimized. Band pass chart 315 shows an example of this.

For patients that have a high pass spectrum of hearing, the ear acts as a high pass filter, which means they have fairly good hearing between approximately 8000 Hz and approximately 12,000 Hz. Frequencies below these are filtered out or minimized. High pass chart 320 shows an example of this.

For patients that have a notch spectrum of hearing, the ear acts as a notch filter, which means they have fairly good hearing between approximately 250 Hz and approximately 4000 Hz and between approximately 8000 Hz and approximately 12,000 Hz, but not between approximately 4000 Hz and approximately 8000 Hz. In the “notch” of this range of frequencies, frequencies are filtered out or minimized. Notch chart 325 shows an example of this.

Based on the values of individual hearing 230 of table 200, an individual would, for example, fall into one of four categories of hearing types: low pass, band pass, high pass, or notch. In table 300, it is assumed that the user's ear behaves as a low pass filter. Based on range of frequencies 330, series of words 345 are marked as troublesome within that particular frequency. In this example, words 1,2, 3, and 4 are troublesome words for a person with low pass hearing, whereas words 6 and 7, etc., are not. Therefore, an individual may need further training on words 1,2, 3, and 4 before a hearing aid is used.

In table 300, each hearing type is further divided into a plurality of frequencies (1 through n), so that the understanding of the user's difficulties can be fine-tuned. In this example, word 1 is a troublesome word in frequency n and word 2 is a troublesome word for frequency 2. The audiologist can thus uniquely identify words in a hearing type (low pass, high pass, etc.), and even words within a hearing type (low pass) that could be troublesome for that user to understand. Indeed, words are patterns of frequency versus amplitude over time that have unique pattern signatures, called phonemes, that allow humans to understand speech. In effect, the brain is trained over time and acts as a real-time DSP and lookup table system to match the pattern signature with a word. Many times, as a person loses his or her hearing in a certain range, certain words become difficult to hear and the user continually asks a speaker to repeat these words. In essence, the user is retraining his or her brain. The word is often provided in a sentence that provides more context for the brain to be retrained. Although the number of words that a human can understand can be quite large (hundreds of thousands), the number of words used in normal vocabulary (95% of normal usage) is about 2000 to 3000 words, which is a feasible number of words for table 300 to include. Thus, table 300 can easily be devised to encompass 95% of the words a human would hear. These words can easily be processed through a DSP to define most of the frequency range; and the words can then be mapped into table 300 against frequency ranges that could be troublesome. This information is vital if training used with various types of hearing loss is required. It is further understood that, for all words 345 in table 300, a sentence could be defined to add context to understanding the word. Just as the user might ask a speaker to repeat a sentence, the user could play a pre-stored sentence over and over again.

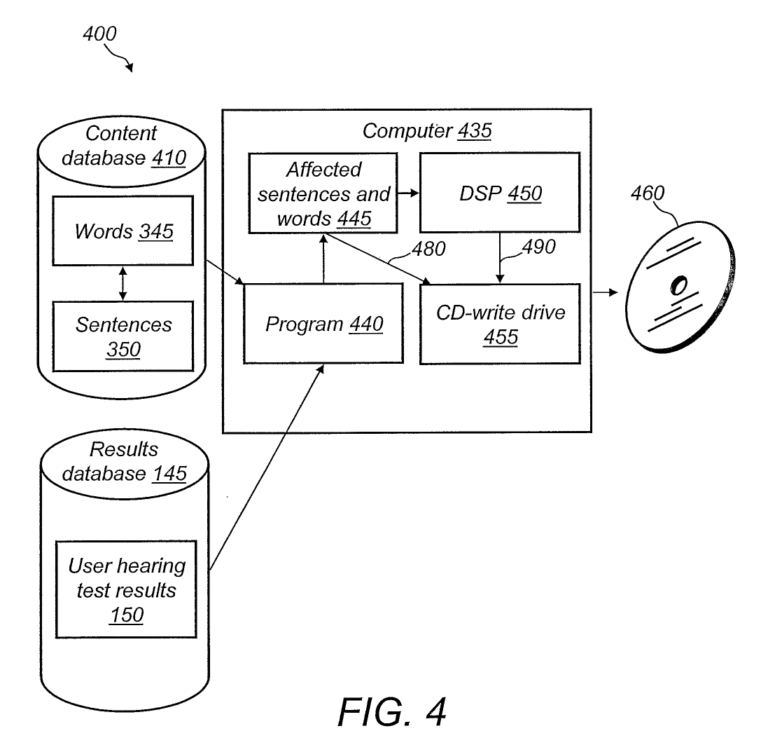

In the series of sentences 350, a single sentence may contain one or more words 345. Furthermore, a single word 345 may have multiple related sentences 350. Such association is described further in FIG. 4.

FIG. 4 shows a high-level system diagram of a system 400 consisting of a content database 410, a group of words 345, a group of sentences 350, database 145, user hearing test results 150, a conventional computer 435, a program 440, an example of affected sentences and words 445, a DSP 450, a CD-write drive 455, and a CD 460.

Content database 410 contains a repository of all words 345 and sentences 350 that cause hearing difficulties. Database 145 contains user hearing test results 150, shown as individual hearing 230 values in FIG. 2 and measured using system 100 of FIG. 1. Computer 435 contains and runs program 440 that essentially performs the association between individual hearing 230 values as shown in FIG. 2 and words 345 and sentences 350 as shown in FIG. 3. Program 440 can write these words or sentences (now shown as affected sentences and words 445) and record them normally (without amplification factor 250 of FIG. 2) to CD-write drive 455 through a path 480. Program 440 can also take affected sentences and words 445 and process them through DSP 450 using amplification factor 250 to record them to CD-write drive 455 through a path 490. Program 440 has the capability to record words or sentences incorporating changes due to amplification factor 250 or perceived hearing 251. All three sets of recordings are then output to CD 460 from CD-write drive 455. Frequency codes to program the hearing aid DSP wirelessly are also recorded. Note that if no prior user information is available on results database 145, then CD 460 can be set to a default program, such as a program for a user with an average level of hearing loss.

In an alternative mode, CD 460 and CD-write drive 455 can be replaced by an alternative communication means such as the Internet. In this mode, program 440 can transfer affected sentences and words 445, with and without amplification factor 250 through DSP 450, to a user through the Internet. Using the Internet can also allow a higher level of interaction with the user over CD 460, since information supplied by the user can be immediately fed back and stored into database 145.

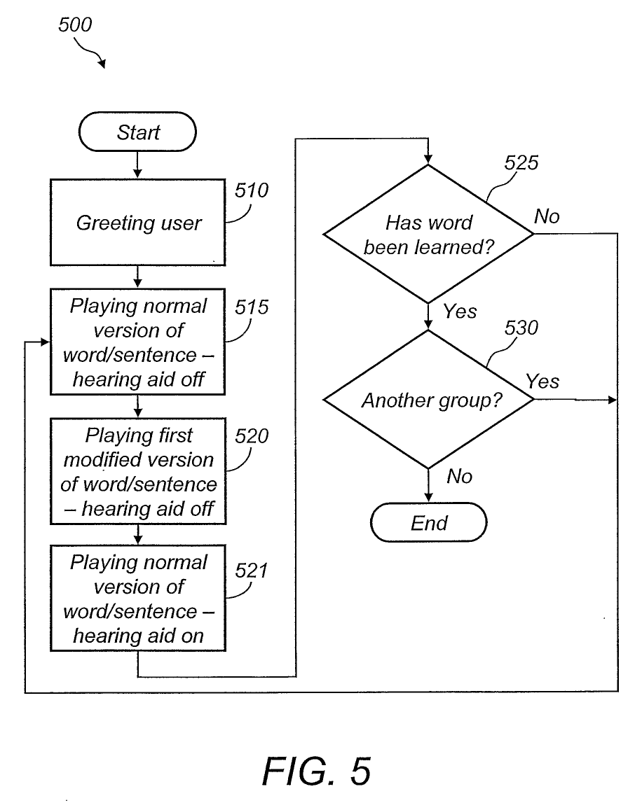

FIG. 5 illustrates a method 500 of using CD 460 as shown in system 400, including the steps of:

Step 510: Greeting User

In this step, a user plays CD 460 and is greeted with a message. The contents of the message can be user specific. For example, a message to welcome the user and introduce the hearing training session can be conveyed as a greeting. The user is instructed to wear his or her hearing aid for the rest of method 500. Method 500 proceeds to step 515.

Step 515: Playing Normal Version of Word/Sentence—Hearing Aid Off

In this step, a user plays the next track on CD 460. CD 460 sends a code to turn off all DSP 450 functioning while keeping the hearing aid's amplifier on so that sound leaves the hearing aid as a simple amplification. (U.S. Pat. No. 6,322,521 describes a wireless connection to a hearing aid through which the hearing aid's DSP can be programmed by sound pulses.) There is an introductory remark as to what will be played next, then the first sentence 350 including the first affected word 345 is played. As an example, this could be word 3 marked under frequency 1 335. Word 345 is played normally, shown in individual hearing 230, as the user hears it without the hearing aid and how the user expects to hear it. For example, in the beginning, the word may sound like: “elephant.” Even though the person speaking the word “elephant” provides the correct frequency and amplitude over time, so that persons with normal hearing understand it as the word “elephant”, the user's poor hearing transmits to his or her brain a degraded frequency and amplitude over time. The user's brain learns this new frequency and amplitude over time as the word “elephant”, but a person of normal hearing would not recognize the word as “elephant”. By playing the normal sentence with the affected words with DSP of the hearing aid off and straight amplification on, the user hears the word and sentence he or she would normally hear and thus “understands” the content and words. Method 500 proceeds to step 520.

Step 520: Playing First Modified Version of Word/Sentence—Hearing Aid Off

In this step, the user plays the next track on CD 460. There is an introductory remark as to what will be next played, then the first sentence 350 including the first affected word 345 is played again; however, it is played adjusted, incorporating amplification factor 250, as the user would hear it with the hearing aid. In the beginning, word 345 may sound like “elephanTT” with an exaggerated frequency “t” component, because that is how the word would sound with the assistance of the hearing aid with its DSP on. Although the user might not understand the word initially, he or she can be trained to understand it by playing it repeatedly.

By playing the modified word with DSP of the hearing aid off but with the hearing aid on, i.e., with simple amplification, the user hears how the hearing aid will change the troublesome word when it is played. This prepares the user for how the hearing aid will modify the spoken words. Method 500 proceeds to step 521.

Step 521: Playing Normal Version of Word/Sentence—Hearing Aid On

In this step, the user plays the next track on CD 460. CD 460 sends a code to turn on DSP of the hearing aid to the functioning condition. (U.S. Pat. No. 6,322,521, incorporated by reference herein, describes a wireless connection to a hearing aid through which the hearing aid's DSP can be programmed by sound pulses.) There is an introductory remark as to what will be played next, then the first sentence 350 including the first affected word 345 is played again normally. However, with the DSP of the hearing aid on, it sounds different to the user. In the beginning, word 345 may sound like “elephenTT” with an exaggerated frequency “t” component. Although the user might not understand the word initially, he or she can be trained to understand it by playing it repeatedly. The user is assisted in his or her training by the comparison between the sounds played in this step and the sounds played in step 520.

It should be noted that, because perceived hearing 251 is known, the program first plays sentences with affected words that are best perceived by the user and continue on to play sentences with affected words that are worst perceived by the user, supplying to the user an easier training routine. Method 500 proceeds to step 525.

Step 525: Has Word Been Learned?

In this decision step, the user determines if he or she is satisfied with the way his or her brain hears and interprets the modified version of the word/sentence combination as played in step 520. If the user understands the word, he or she has learned it; if the user does not understand the word, he or she can replay the track until he or she is accustomed to the modified version of the word. If the user feels that he or she has learned the word, method 500 proceeds to step 530; if not, method 500 returns to step 515.

It is easily understood that individual users differ in speed of learning words, i.e. they learn words faster or slower than others. Therefore in an alternative mode of this invention, a feature can be provided where the users' speed and ability to grasp words is analyzed for customizing and fitting a programmable hearing aid. More so, this feature can be made iterative, such that an on-going analysis of the users' improvements in grasping words can be used to further fine-tune the users hearing aid over time.

Step 530: Another Group?

In this decision step, the user determines if he or she would like to review additional groups of words/sentences. If yes, method 500 returns to step 515; if not, method 500 ends.

What is claimed is:

1. A system for creating a training product customized for an individual based on his or her hearing profile, for fitting a hearing aid, the system comprising
means for collecting user information data by conducting a hearing test;
means for storing the collected data in a database;
a hearing aid including a DSP;
means for determining specific words the user has difficulty understanding based on the user's hearing profile and the expected performance of the hearing aid.

2. The system of claim 1, wherein the specific words are changed to a frequency and amplitude using the DSP in the hearing aid.

3. The system of claim 2, wherein the hearing test data and changes using the DSP, provides for creating a customized CD training system of a content including words and sentences that can be used to train the individual to use the hearing aid.

4. The system of claim 3, wherein the content can be outputted to a CD using a low-cost system with minimal waiting by the consumer.

5. A method of training an individual to use a hearing aid based on hearing loss characteristics of the individual, the method comprising the steps of:
collecting frequency and amplitude hearing loss data for the individual by performing a frequency versus amplitude hearing test on the individual;
generating a hearing loss profile map including frequencies requiring amplification and associated amplification factors and perceived hearing values based on the frequency and amplitude data.

6. The method of claim 5, further comprising the steps of
providing a word database, wherein the database includes a plurality of words, wherein each of the words includes at least one frequency component and is indexed in the database in accordance with the at least one frequency component.

7. The method of claim 6, further comprising the steps of generating training word units, wherein each of the training units includes a troublesome word from the word database having at least one frequency component substantially equal to one of the frequencies requiring amplification in a profile map.

8. The method of claim 7, wherein each of the training units further includes the amplification factor for one of the frequencies requiring amplification.

9. The method of claim 8; further comprising the step of
storing the training units on data storage units of at least one of a fixed and portable data storage media.

10. The method of claim 9, wherein each of the training units is stored on the media including a hearing aid amplification factor activation sound code and such that a normal version and a modified version of the word included in the training unit can be generated as a sound output.

11. The method of claim 10, wherein the normal version sound output is without any amplification and the modified version sound output includes selected amplification of the word based on the amplification factor.

12. The method of claim 5, further comprising the steps of storing the training units on the media such that the individual can selectively generate, for each of the training units, sound output of the sound code and the normal and modified version of the word of one of the training units.

13. The method of claim 12, wherein the normal version sound output of the word is automatically generated following selection of the sound code sound output.

14. The method of claim 11, further comprising the step of
storing the training units on the media such that, when the media is initially accessed by the individual, the training units are made accessible to the individual in an order starting from the training unit including the troublesome word likely to be best perceived and terminating at the training unit including the troublesome word likely to be worst perceived by the individual.

15. A system for creating a training product customized for an individual based on his or her hearing profile, the system comprising
a portable data storage media including training words stored and arrange on a medium for providing the method of claim 12.
